(19) United States
(12) Patent Application Publication
(10) Pub. No.: US 2002/0118839 A1
(43) Pub. Date: Aug. 29, 2002

(54) Circuit for providing a widened stereo image

(75) Inventor: Wayne M. Schott, Seymour, TN (US)

Correspondence Address: Michael E. Marion, c/o U.S. PHILIPS CORPORATION, Intellectual Property Department, 580 White Plains Road, Tarrytown, NY, 10591, US

(73) Assignee: PHILIPS ELECTRONICS NORTH AMERICA CORPORATION

(21) Appl. No.: 09/749,707

(22) Filed: Dec. 27, 2000

(51) Int. Cl. H04R 5/00

(52) U.S. Cl. 381/1; 381/17; 381/18

(57) ABSTRACT

By using special frequency response manipulation in the difference channel of a stereo signal, the stereo image appears to extend beyond the actual placement of the loudspeakers. This is accomplished by shaping the difference channel response to simulate the response one would be subjected to if the sources were physically moved to the virtual position, and by additionally cancelling the crosstalk effect in each channel.

### BACKGROUND OF THE INVENTION

1. Field Of The Invention

The subject invention relates to a signal processing circuit for enhancing a stereo image that corresponds to a stereo audio signal.

2. Description Of The Related Art

In conventional stereo systems, the amplifying circuits amplify the left and right channel signals and pass these amplified signals to left and right channel loudspeakers. This is done in an attempt to simulate the experience of a live performance in which the reproduced sounds emanate from different locations. Since the advent of stereo systems, there has been continual development of systems which more closely simulate this experience of a live performance. For example, in the early to mid 1970's, four-channel stereo systems were developed which included two front left and right channel loudspeakers and two rear left and right channel loudspeakers. These systems attempted to recapture the information contained in signals reflected from the back of a room in which a live performance was being held. More recently, surround sound systems are currently on the market which, in effect, seek to accomplish the same effect.

A drawback of these systems is that there are four or more channels of signals being generated and a person must first purchase the additional loudspeakers and then solve the problem of locating the multiple loudspeakers for the system.

U.S. Pat. No. 5,761,313 discloses a circuit for improving the stereo image separation of a stereo signal in which spatial frequency response manipulation in the different channels of a stereo system is used to cause the stereo image to appear to extend beyond the actual placement of the loudspeakers. This is accomplished by shaping the difference channel response to simulate the response one would be subjected to if the sources were physically moved to the virtual positions.

U.S. Pat. No. 4,349,698 discloses that a stereo widening effect may be achieved by examining the head related transfer functions at different source positions and incorporating the response characteristics that are obtained in the (L−R) part of the stereo signal.

### SUMMARY OF THE INVENTION

It is an object of the present invention to further enhance the stereo image of an input stereo signal to achieve a greater stereo spread than that exhibited in the prior art.

The above object is achieved in a circuit arrangement for improving the stereo image separation in a stereo signal comprising a first and a second input for receiving, respectively, a left and a right channel signal of an input stereo signal; a summing and equalizing circuit having a first and a second input coupled, respectively, to said first and second inputs of said circuit arrangement, for receiving said left and right channel signals, means for summing the left and right channel signals thereby forming a sum signal, and a first and a second output for supplying the sum signal; a difference and equalizing circuit having a first and a second input coupled, respectively, to said first and second inputs of said circuit arrangement, for receiving said left and right channel signals, means for subtracting the right channel signal from the left channel signal forming a difference signal, means for performing and equalization on said difference signal, said equalization having characteristics of an ear of a human being, means for processing said difference signal in order to effectively cancel crosstalk effects of the left channel signal reaching the right channel output and the right channel signal reaching the left channel output, and first and second outputs for providing, respectively, the equalized difference signal; first means for combining the first output of said summing and frequency equalizing circuit with the first output of said difference and frequency equalizing circuit to form a modified left channel output signal; second means for combining the second output of said summing and frequency equalizing circuit with the second output of said difference and frequency equalizing circuit to form a modified right channel output signal; and first and second outputs for providing said modified left and right channel output signals, respectively.

Applicant has found that by cancelling the effects of crosstalk in the left or right signals reaching the ear of a listener, in addition to creating a frequency response that simulates the response correction that is necessary when the sound source is moved from a position directly in front of the listener to a position 90 degrees to the side of the listener, a signal is then presented to each ear of a listener that not only has the correct frequency response correction based on source positioning, but also isolates the source to the proper ear.

### BRIEF DESCRIPTION OF THE DRAWINGS

With the above and additional objects and advantages in mind as will hereinafter appear, the invention will be described with reference to the accompanying drawings, in which:

FIG. 1 is a block diagram of the circuit of the invention;

FIG. 2 is a schematic block diagram of a first embodiment of the circuit of the invention;

FIGS. 3 and 4 show response curves for the embodiment of FIG. 2;

FIG. 5 is a schematic block diagram of a second embodiment of the circuit of the invention;

FIGS. 6-8 show response curves for the embodiment of FIG. 5;

FIG. 9 is a schematic block diagram of a third embodiment of the circuit of the invention; and

FIGS. 10 and 11 show response curves for the embodiment of FIG. 9.

### DESCRIPTION OF THE PREFERRED EMBODIMENTS

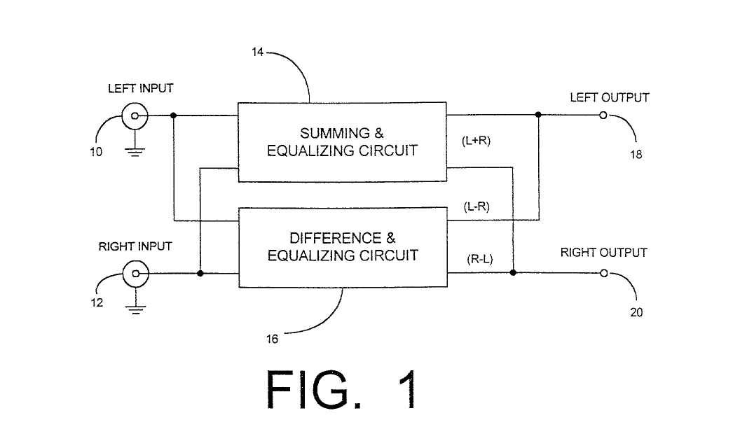

FIG. 1 shows a basic schematic block diagram of the subject invention. A first and a second input 10 and 12 receive the left and right channel signals from a stereo signal source. The left channel signal is applied both to a first input of a summing and frequency equalizing circuit 14 and to a first input of a difference and frequency equalizing circuit 16. The right channel signal is similarly both to a second input of the summing and frequency equalizing circuit 14 and to a second input of the difference and frequency equalizing circuit 16. The summing and frequency equalizing circuit 14 adds the signals applied to its first and second inputs and then optionally performs a high frequency equalization on the combined signal (L+R). This combined signal is then supplied to a first and a second output of the summing and frequency equalizing circuit 14.

The difference and frequency equalizing circuit 16 forms a first and a second difference signal (L−R and R−L), from the left and right channel signals applied to the first and second inputs. The difference and frequency equalizing circuit 16 then performs a frequency equalization, with respect to the response of the ear of a person on the difference signal to shape the response to simulate that which would be perceived by the person if the sound sources (loudspeakers) were actually placed at virtual positions, i.e., wider and directly opposite the persons ears. In addition, the difference and frequency equalizing circuit 16 further cancels the crosstalk effect of the left or right channel signal reaching the respective opposite ear. As such, the difference and frequency equalizing circuit 16 not only performs a frequency response correction based on source positioning, but also isolates the source to the proper ear.

The processed difference signal (L−R) is applied to a first output of the difference and frequency equalizing circuit 16 while the processed difference signal (R−L) is applied to a second output of the difference and frequency equalizing circuit 16. The first output of the difference and frequency equalizing circuit 16 is combined with one of the outputs of the summing and frequency equalizing circuit 14 to form the left channel output signal 18, and the second output of the difference and frequency equalizing circuit 16 is combined with the other output of the summing and frequency equalizing circuit 14 to form the right channel output signal 20.

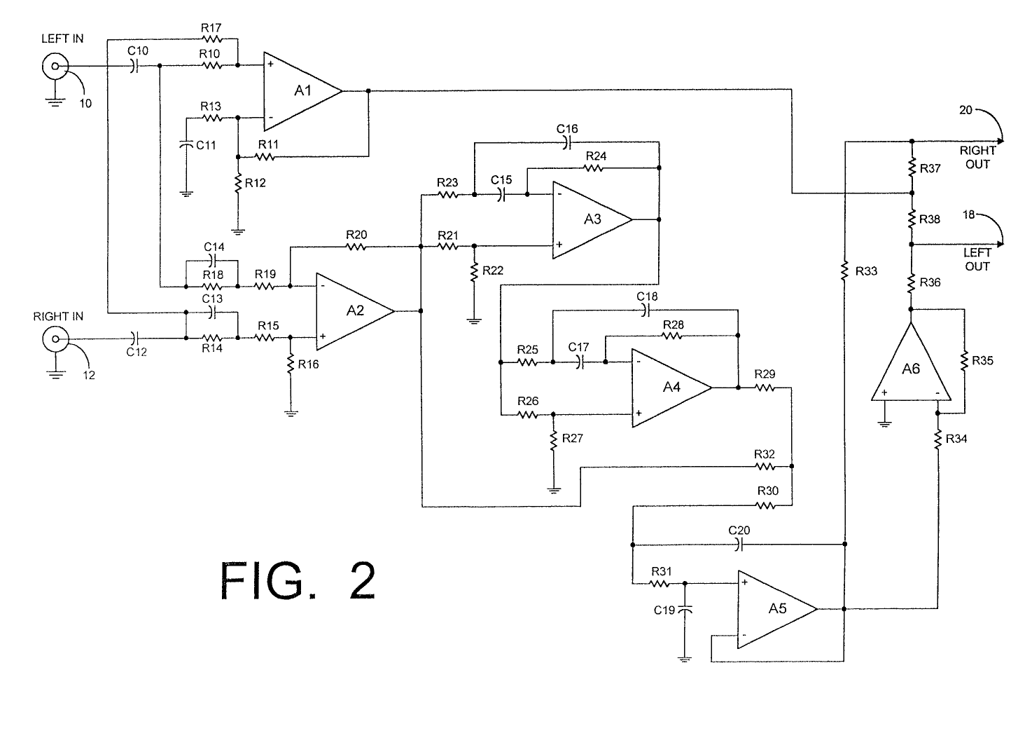

FIG. 2 shows a schematic diagram of a first embodiment of the circuit arrangement of FIG. 1. The left channel input 10 is applied to a capacitor C10 and then through a resistor R10 to the non-inverting input of a first operation amplifier (OP-AMP) A1. The inverting input of OP-AMP A1 is connected to the output through a resistor R11 and to ground via a resistor R12 and via the series combination of a resistor R13 and a capacitor C11.

The right channel input 12 is applied to a capacitor C12 and then through a resistor R14, shunted by a capacitor C13, and a resistor R15 to the non-inverting input of OP-AMP A2, which is further connected to ground via a resistor R16. The right channel input 12 is also connected, via the capacitor C12, to a resistor R17 connected to the non-inverting input of OP-AMP A1. In addition, the left channel input 10 is also connected, via the capacitor C10, through a resistor R18, shunted by a capacitor C14, and a resistor R19, to the inverting input of OP-AMP A2.

A resistor R20 connects the inverting input of OP-AMP A2 to its output, which is in turn connected through resistor R21 to the non-inverting input of OP-AMP A3, which is connected to ground via a resistor R22. The output of OP-AMP A2 is further connected to the inverting input of OP-AMP A3 through the series arrangement of a resistor R23 and a capacitor C15. The inverting input of OP-AMP A3 is connected to its output via a resistor R24, while the junction between resistor R23 and capacitor C15 is connected to the output of OP-AMP A3 via a capacitor C16.

The output of OP-AMP A3 is connected, on the one hand, to the inverting input of OP-AMP A4 via the combination of a resistor R25 and a capacitor C17, and, on the other hand, to the non-inverting input of OP-AMP A4 via a resistor R26, which is connected to ground through a resistor R27. A resistor R28 connects the inventing input of OP-AMP A4 to its output, while a capacitor C18 connects the junction between resistor R25 and capacitor C17 to the output of OP-AMP A4.

The serial arrangement of resistors R29, R30 and R31 connects the output of OP-AMP A4 to the non-inverting input of OP-AMP A5, which is further connected to ground via a capacitor C19. A resistor R32 connects the output of OP-AMP A2 to the junction between resistors R29 and R30. The inverting input of OP-AMP AS is connected directly to the output thereof, while a capacitor C20 connects the junction between resistors R30 and R31 to the output.

The output of OP-AMP A5 is connected to the right channel output 20 of the circuit arrangement via a resistor R33, and is further connected to the inverting input of OP-AMP A6 via a resistor R34, the non-inverting input being connected to ground. A resistor R35 connects the inverting input of OP-AMP A6 to its output which is then connected to the left channel output 18 via a resistor R36. A pair of resistors R37 and R38 interconnect the left and right channel outputs 18 and 20, while the output from OP-AMP A1 is connected to the junction between the resistors R37 and R38.

In FIG. 2, OP-AMP A1 acts as the summing portion of circuit 14 in FIG. 1 for summing the left and right channel signals, and also performs a high frequency equalization on this sum signal (L+R). OP-AMP A2 forms the difference between the right and left channel signals (R−L), while OP-AMP's A3 and A4 together form a mid- and high-range human ear equalizer (part of circuit 16 in FIG. 1). By processing this equalized version of the difference signal (R−L) from OP-AMP A5 as well as its inverse (L−R) formed in OP-AMP A6, along with the equalized sum signal (L+R) in the resistance bridge formed by resistors R37 and R38, any crosstalk is removed from the left and right channel output signals.

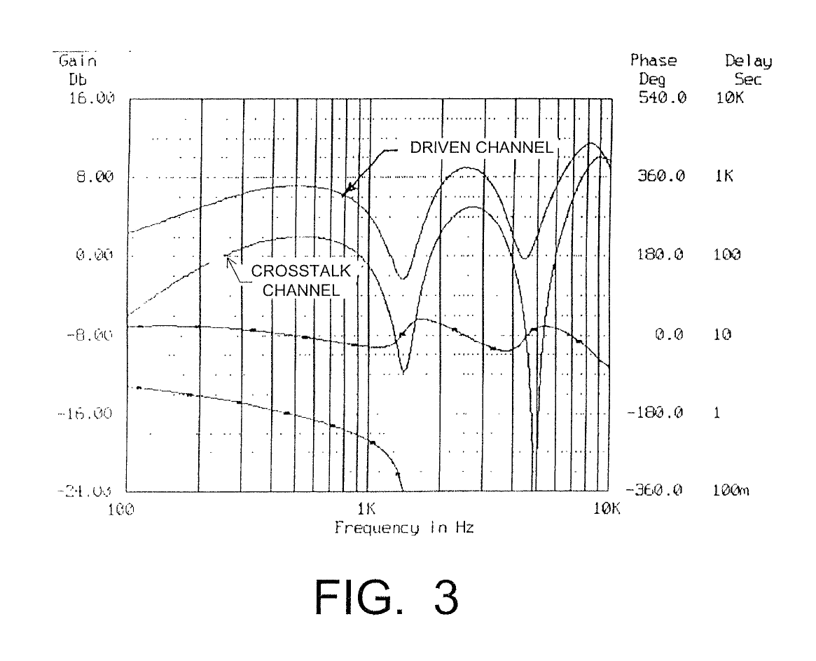

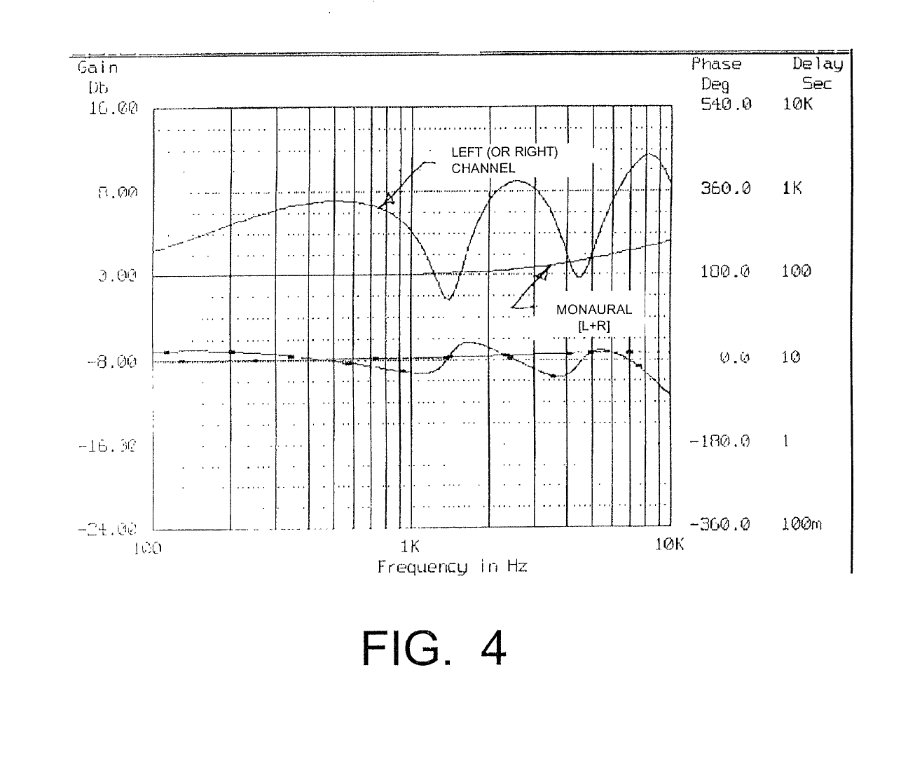

FIGS. 3 and 4 show response curves for the first embodiment of FIG. 2, where FIG. 3 shows the response curve of a driven channel (left or right) as compared to the crosstalk channel, and FIG. 4 shows the response curve of either the left or right channel as compared to the monaural channel (at the output of OP-AMP A1).

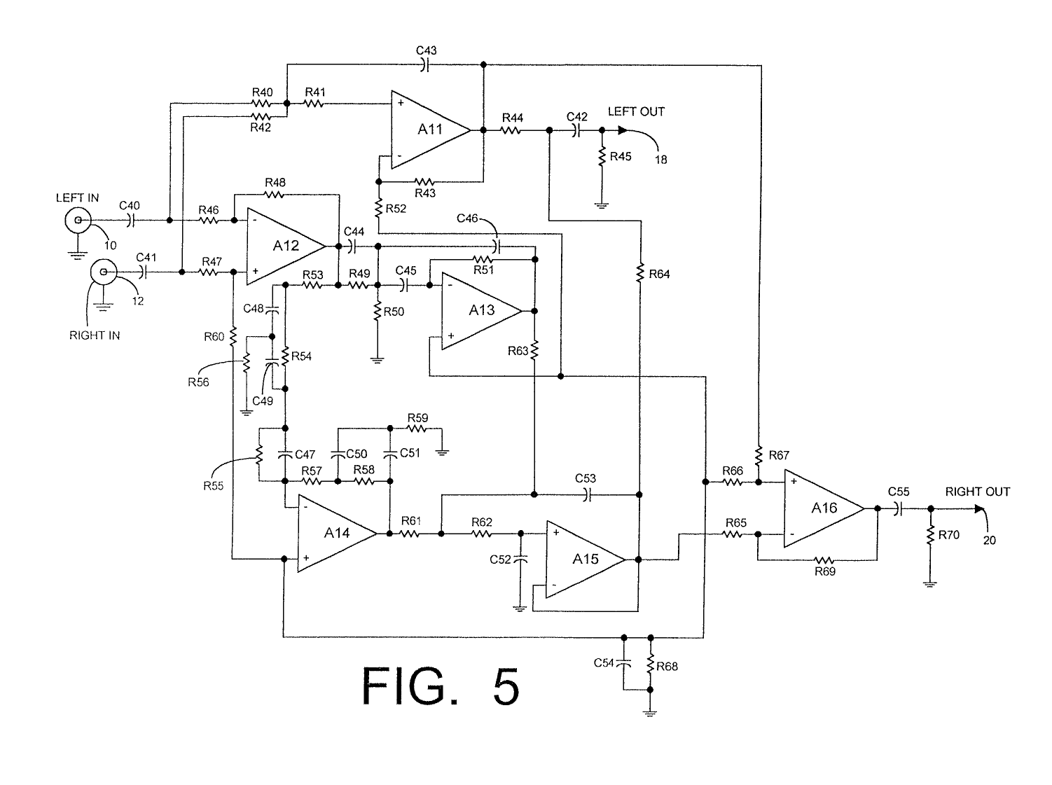

FIG. 5 is a schematic diagram of a second embodiment of the circuit arrangement of the subject invention. The left channel input 10 is applied to a capacitor C40 and then through resistors R40 and R41 to the non-inverting input of OP-AMP A11. The right channel input 12 is applied to a capacitor C41 and then through a resistor R42 to the junction of resistors R40 and R41. A resistor R43 connects the inverting input of OP-AMP A11 to its output which is then connected through the series arrangement of a resistor R44 and a capacitor C42 to the left channel output 18, which is connected to ground through a resistor R45.

The left channel input 10 is also connected, through the capacitor C40 and a resistor R46, to the inverting input of OP-AMP A12, while the right channel input 12 is connected, through the capacitor C41 and a resistor R47, to the non-inverting input of OP-AMP A12. A resistor R48 connects the inverting input of OP-AMP A12 to its output which is connected through the parallel combination of capacitor C44 and resistor R49, in series with capacitor C45, to the inverting input of OP-AMP A13, the junction between resistor R49 and capacitor C45 being connected to ground through resistor R50, and to the output of OP-AMP A13 through a capacitor C46. The inverting input of OP-AMP A13 is connected to its output through resistor R51. The inverting input of OP-AMP A12 is connected to the non-inverting input of OP-AMP A13 through a resistor R52.

The output of OP-AMP A12 is further connected through a resistor R53, resistor R54 and a parallel combination of a resistor R55 and a capacitor C47 to the inverting input of OP-AMP A14. The resistor R54 is shunted by the series arrangement of capacitors C48 and C49, in which the junction between these capacitors is connected to ground through a resistor R56. A series arrangement of resistors R57 and R58 connect the inverting input of OP-AMP A14 to its output, while a series arrangement of a capacitor C50 and a resistor R59 connect the junction between the resistors R57 and R58 to ground, a capacitor C51 connecting the output of OP-AMP A14 to the junction between the capacitor C50 and the resistor R59. A resistor R60 connects the non-inverting input of OP-AMP A12 to the non-inverting input of OP-AMP A14.

A series arrangement of resistors R61 and R62 connect the output of OP-AMP A14 to the non-inverting input of OP-AMP A15, a capacitor C52 connecting the non-inverting input to ground. The inverting input of OP-AMP A15 is connected to its output. A resistor R63 connects the output from OP-AMP A13 to the junction between the resistors R61 and R62, which is connected to the output of OP-AMP A15 through a capacitor C53. A resistor R64 connects the junction between the resistor R44 and capacitor C42 (at the output of OP-AMP A11) to the output of OP-AMP A15.

The output of OP-AMP A15 is connect to the inverting input of OP-AMP A16 through a resistor R65, while a resistor R66 connects the non-inverting inputs of OP-AMP's A13 and A14 to the non-inverting input of OP-AMP A16, which is further connected to the output of OP-AMP A11 through a resistor R67. The connection between the non-inverting input of OP-AMP A14 and the resistor R66 is connected to ground through the parallel arrangement if a capacitor C54 and a resistor R68. A resistor R69 connects the inverting input of OP-AMP A16 to its output, which is connected, through capacitor C55, to the right channel output 20, this output being connected to ground through a resistor R70.

In FIG. 5, the sum signal (R+L) is formed at the non-inverting input of OP-AMP A11, while OP-AMP A12 forms the difference signal (R−L). OP-AMP A13 receives a first equalized version of the difference signal (R−L) and produces a first equalized “(L−R)” signal. OP-AMP A14 also receives a second equalized version of the difference signal (R−L) and produces a second equalized “(L−R)” signal. These two “(L−R)” signals are combined at the input of OP-AMP A15 which applies the resulting “(L−R)” signal to the inverting input of OP-AMP A16. The OP-AMP A16 receives at its non-inverting input the sum signal, and as such, produces the right channel output signal. The OP-AMP A11 supplies the sum signal “(L+R)” at its output. When the “(L+R)” signal at the output of OP-AMP A11 is combined with the “(L−R)” signal from the output of OP-AMP A15 at the junction of resistor R44 and capacitor C42, the left channel output signal is formed.

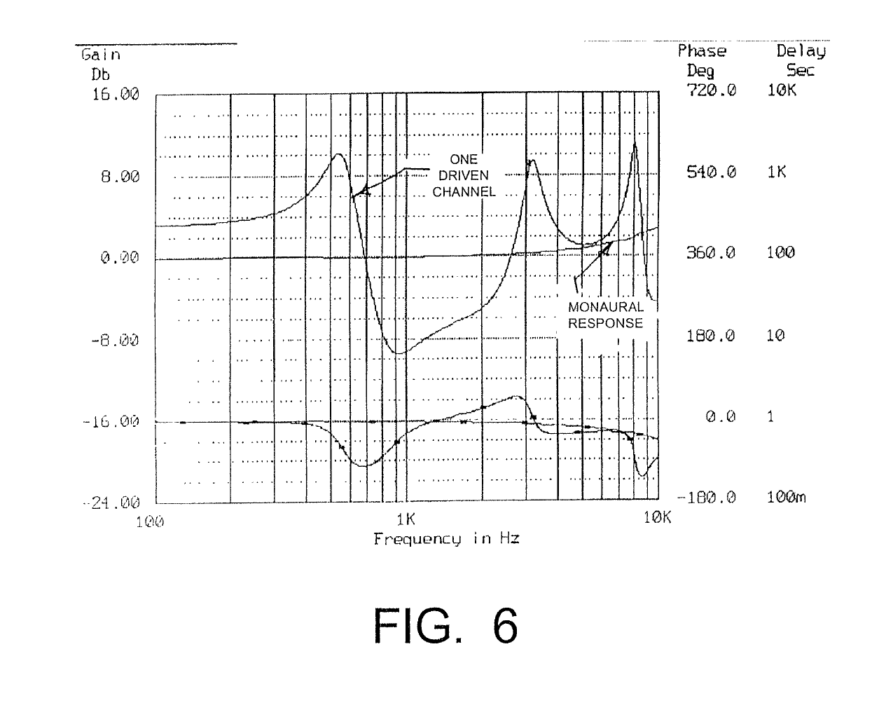

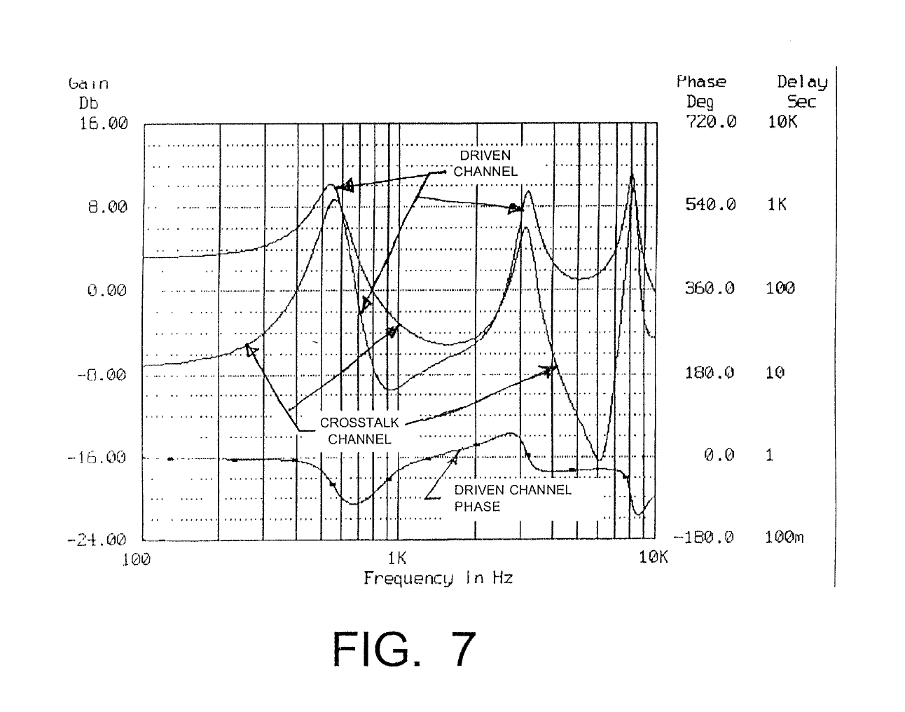

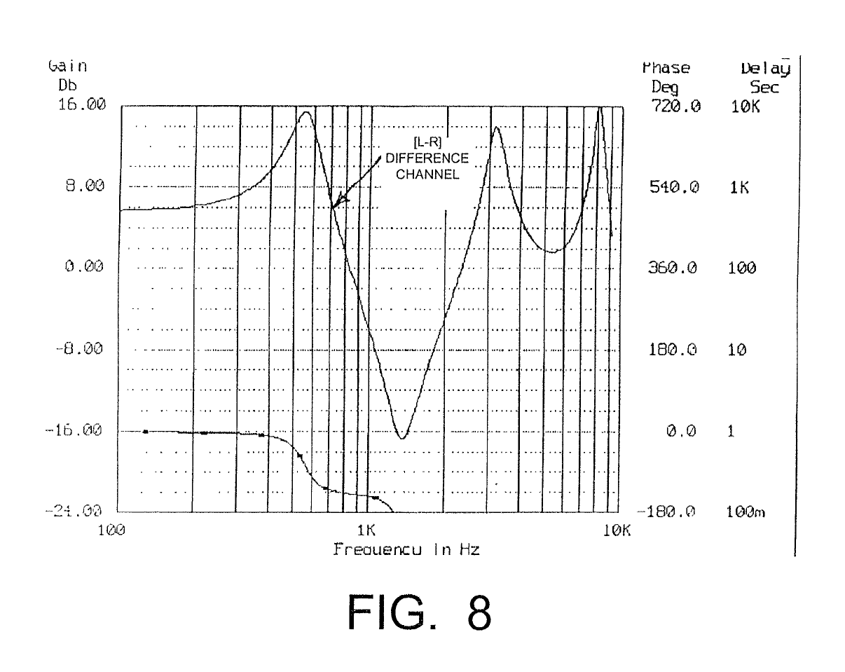

FIGS. 6-8 show response curves for the second embodiment of FIG. 5, where FIG. 6 shows the response curve of one driven channel as compared with the monaural (L+R) response, FIG. 7 shows the response curve of one driven channel as compared with the crosstalk channel, as well as the phase of the driven channel, and FIG. 8 shows the response curve of the difference (L−R) channel (at the output of OP-AMP A15).

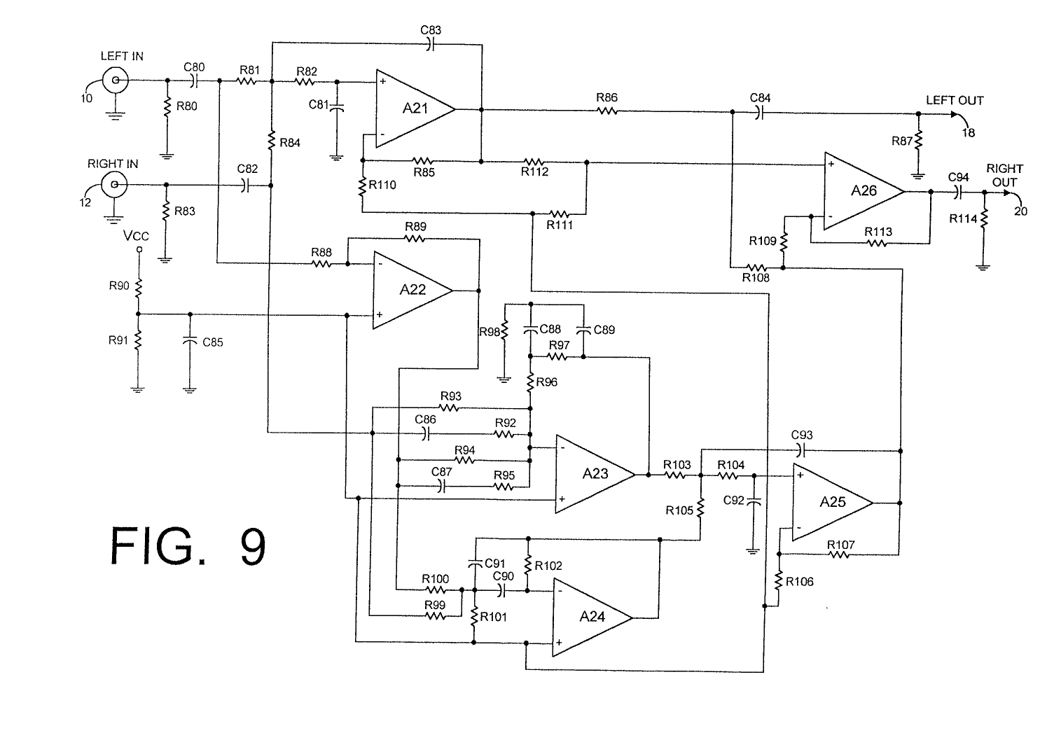

FIG. 9 is a schematic diagram of a third embodiment of the circuit arrangement of the subject invention. The left channel input, coupled to ground via a resistor R80, is connected through the series arrangement of a capacitor C80, and a pair of resistors R81 and R82, to the non-inverting input of OP-AMP A21, which is connected to ground via a capacitor C81. The right channel input, coupled to ground via a resistor R83, is connected through a capacitor C82 and a resistor R84 to the junction between resistors R81 and R82, this junction being connected to the output of OP-AMP A21 via a capacitor C83. A resistor R85 connects the inverting input of OP-AMP A21 to its output, which is connected via a resistor R86 and a capacitor C84 to the left channel output 18, which is connected to ground via a resistor R87.

The junction between capacitor C80 and resistor R81 is connected, via a resistor R88, to the inverting input of OP-AMP A22, this inverting input being connected to the output via a resistor R89. A pair of resistors R90 and R91 connect a voltage source Vcc to ground, the junction between these resistors being connected to ground via a capacitor C84 and to the non-inverting input of OP-AMP A22.

The junction between capacitor C82 and resistor R84 is connected, on the one hand, through the series arrangement of a capacitor C86 and a resistor R92, and, on the other hand, through a resistor R93, to the inverting input of OP-AMP A23. The output of OP-AMP A22 is connected, on the one hand, through a resistor R94, and, on the other hand, through the series arrangement of a capacitor C87 and a resistor R95, also to the inverting input of OP-AMP A23. The non-inverting input of OP-AMP A23 is connected to the non-inverting input of OP-AMP A22. The inverting input of OP-AMP A23 is connected to its output via the series arrangement of resistors R96 and R97, in which the junction between these resistors is connected to ground via the series arrangement of a capacitor C88 and a resistor R98, while a capacitor C89 connects the output of OP-AMP A23 to the junction between capacitor C88 and resistor R98.

The junction between capacitor C82 and resistor R84 is further connected, via a resistor R99 and a capacitor C90 to the inverting input of OP-AMP A24, while output of OP-AMP A22 is connected through a resistor R100 to the junction between resistor R99 and capacitor C90. The non-inverting input of OP-AMP A23 is connected to the non-inverting input of OP-AMP A24, which is connected to the junction between resistor R99 and capacitor C90 by a resistor R101. A resistor R102 connects the inverting input of OP-AMP A24 to its output while a capacitor C91 connects the junction between resistor R99 and capacitor C90 to the output.

The output of OP-AMP A23 is connected through resistors R103 and R104 to the non-inverting input of OP-AMP A25, which is connected to ground via a capacitor C92, and the output of OP-AMP A24 is connected to the junction of resistors R103 and R104 through a resistor R105, which is, in turn, connected to the output of OP-AMP A25 through a capacitor C93. The non-inverting input of OP-AMP A24 is connected, through a resistor R106, to the inverting input of OP-AMP A25, which is connected, through a resistor R107, to its output.

The output of OP-AMP A25 is connected, on the one hand, to the junction between resistor R86 and capacitor C84 through a resistor R108, and, on the other hand, to the inverting input of OP-AMP A26 through a resistor R109. Resistors R110 and R111 connect the inverting input of OP-AMP A21 to the non-inverting input of OP-AMP A26, while the junction between resistors R110 and R111 is connected to the non-inverting input of OP-AMP A24. A resistor R113 connects the inverting input of OP-AMP A26 to its output which is connected, through a capacitor C94, to the right channel output 20, which is connected to ground via a resistor R114.

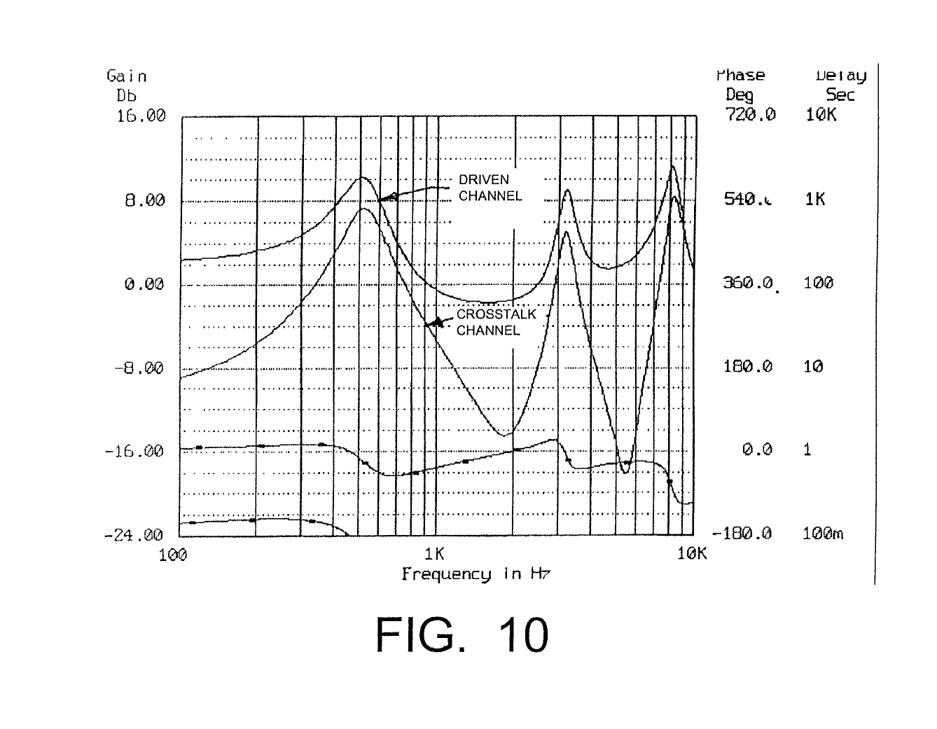

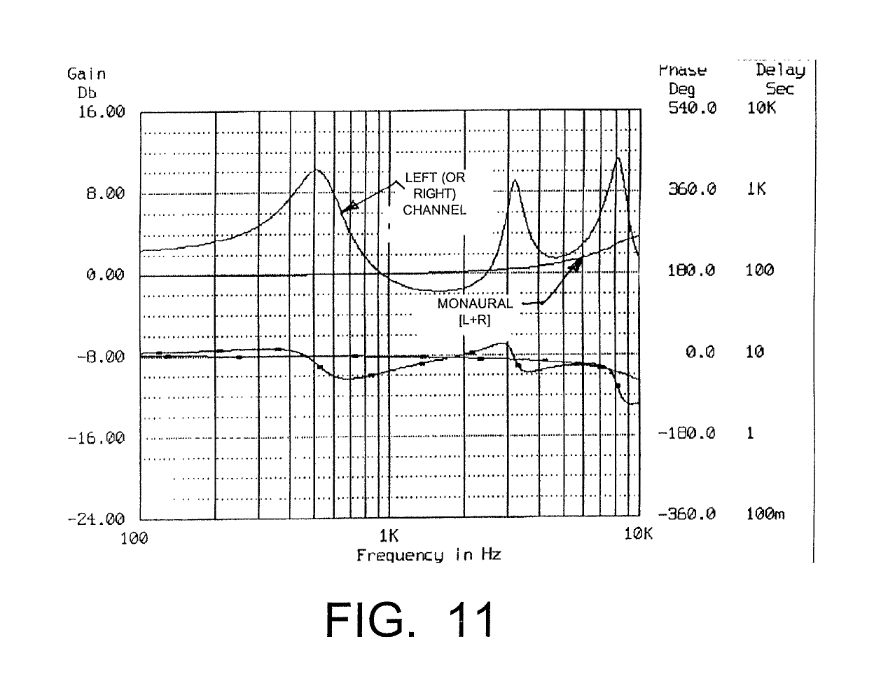

FIGS. 10 and 11 show response curves for the third embodiment of FIG. 9, where FIG. 10 shows the response curve of a driven channel as compared to the crosstalk channel, and FIG. 11 shows the response curve of either the left or right channel as compared to the monaural (L+R) channel (at the output of OP-AMP A21).

The values of the circuit components used in FIGS. 2, 5 and 9 are as follows:

| RESISTORS | VALUE (in ohms) |
|---|---|
| R10, R17 | 22K |
| R11, R28 | 39K |
| R12, R13, R15, R19, R25 | 10K |
| R14, R18 | 33K |
| R16, R20 | 68K |
| R21, R22, R26, R27 | 47K |
| R23 | 8.2K |
| R24 | 30K |
| R29 | 1.5K |
| R30 | 13K |
| R31 | 15K |
| R32 | 5.1K |
| R33, R34, R35, R36 | 1K |
| R37, R38 | 3.9K |

| | |
|---|---|
| CAPACITORS | VALUE |

| | | |
|---|---|---|
| C10, C12 | 5 | μF |
| C11 | 1.5 | NF |
| C13, C14 | 68 | NF |
| C15, C16 | 2.7 | NF |
| C17, C18, C20 | 4.7 | NF |
| C19 | 330 | PF |

| RESISTORS | VALUE (in ohms) |
|---|---|
| R40, R42, R48, R60 | 22K |
| R41, R43, R52, R62 | 15K |
| R44, R64, R68 | 1K |
| R45, R70 | 100K |
| R46, R47, R66, R69 | 10K |
| R49 | 27K |
| R50, R56, R59 | 1.1K |
| R51 | 220K |
| R53 | 4.7K |
| R54 | 6.8K |
| R55, R63 | 33K |
| R57 | 5.6K |
| R58 | 68K |
| R61 | 30K |
| R65, R67 | 20K |

| | |
|---|---|
| CAPACITORS | VALUE |

| | | |
|---|---|---|
| C40, C41, C42, C55 | 5 | μF |
| C43 | 1 | NF |
| C44 | 680 | PF |
| C45, C46 | 3.3 | NF |
| C47 | 6.8 | NF |
| C48, C49, C50, C51, C53 | 33 | NF |
| C52 | 47 | PF |
| C54 | 100 | μF |

| RESISTORS | VALUE (in ohms) |
|---|---|
| R80, R83, R87, R114 | 100K |
| R81, R84, R85, R106, R107, R110, R111, R113 | 10K |
| R82 | 15K |
| R86, R90, R91, R108 | 1K |
| R88, R89 | 22K |
| R92, R94 | 3.9K |
| R93, R95, R99, R100, R103, R105 | 33K |
| R96 | 5.6K |
| R97 | 47K |
| R98 | 1.8K |
| R101 | 1.1K |
| R102 | 220K |
| R104, R109, R112 | 20K |

| | |
|---|---|
| CAPACITORS | VALUE |

| | | |
|---|---|---|
| C80, C82, C84, C94 | 5 | μF |
| C81 | 1 | NF |
| C83 | 2.2 | NF |
| C85 | 100 | μF |
| C86, C87 | 2.7 | NF |
| C88, C89 | 33 | NF |
| C90, C91 | 3.3 | NF |
| C92 | 750 | PF |
| C93 | 1.5 | NF |

Numerous alterations and modifications of the structure herein disclosed will present themselves to those skilled in the art. However, it is to be understood that the above described embodiment is for purposes of illustration only and not to be construed as a limitation of the invention. All such modifications which do not depart from the spirit of the invention are intended to be included within the scope of the appended claims.

What is claimed is:

1. A circuit arrangement for improving the stereo image separation in a stereo signal comprising:
a first and a second input for receiving, respectively, a left and a right channel signal of an input stereo signal;
a summing and equalizing circuit having a first and a second input coupled, respectively, to said first and second inputs of said circuit arrangement, for receiving said left and right channel signals, means for summing the left and right channel signals thereby forming a sum signal, means for equalizing said sum signal, and a first and a second output for supplying the equalized sum signal;
a difference and equalizing circuit having a first and a second input coupled, respectively, to said first and second inputs of said circuit arrangement, for receiving said left and right channel signals, means for subtracting the right channel signal from the left channel signal forming a difference signal, means for performing and equalization on said difference signal, said equalization having characteristics of an ear of a human being, means for processing said difference signal in order to effectively cancel crosstalk effects of the left channel signal reaching the right channel output and the right channel signal reaching the left channel output, and first and second outputs for providing, respectively, the equalized difference signal;
first means for combining the first output of said summing and frequency equalizing circuit with the first output of said difference and frequency equalizing circuit to form a modified left channel output signal;
second means for combining the second output of said summing and frequency equalizing circuit with the second output of said difference and frequency equalizing circuit to form a modified right channel output signal; and
first and second outputs for providing said modified left and right channel output signals, respectively.

2. The circuit arrangement as claimed in claim 1, wherein said summing and equalizing circuit comprises an operational amplifier having a non-inverting input coupled to said first and second inputs, and means coupled to said operational amplifier for causing said operational amplifier to perform a high frequency equalization.

3. The circuit arrangement as claimed in claim 1, wherein said difference and equalizing circuit comprises an operational amplifier having an inverting input coupled to said first input and a non-inverting input coupled to said second input.

4. The circuit arrangement as claimed in claim 3, wherein said processing means and said first and second combining means comprise matrix means for receiving said equalized sum signal and said equalized difference signal, said matrix circuit forming said modified left and right channel output signals.

5. The circuit arrangement as claimed in claim 4, wherein said matrix means comprises a single matrix circuit.

6. The circuit arrangement as claimed in claim 4, wherein said matrix means comprises a first matrix circuit for forming said modified left channel output signal, and a second matrix circuit for forming said modified right channel output signal.
